(19) United States
(12) Patent Application Publication
(10) Pub. No.: US 2023/0071375 A1
(43) Pub. Date: Mar. 9, 2023

(54) PROTECTING CONFIDENTIALITY OF AIR-GAPPED LOGS

(71) Applicant: Motional AD LLC, Boston, MA (US)

(72) Inventors: Xiangrong Li, Newton, MA (US); Michael Maass, Pittsburgh, PA (US); Andrew Spangler, Medford, MA (US); Marwan Abi-Antoun, Natick, MA (US)

(21) Appl. No.: 17/467,142

(22) Filed: Sep. 3, 2021

(51) Int. Cl. G06F 12/14; G06F 21/62; G06F 21/60; G06F 21/74

(52) U.S. Cl. CPC G06F 12/1466; G06F 12/1408; G06F 21/6227; G06F 21/602; G06F 21/74; G06F 2221/2143

(57) ABSTRACT

A method of protecting confidentiality of air-gapped logs comprises: generating, during a first log processing cycle, a data processor key and a drive encryption key, wherein the data processor key and the drive encryption key are unique to a log drive mounted to at least one computer processor; wrapping the drive encryption key with the computer processor key; storing the drive encryption key wrapped by the computer processor key in a database, where the database is mapped to data uniquely identifying the log drive; wrapping the drive encryption key with a default key that is known to at least one originator device; wiping the log drive; and writing the drive encryption key wrapped by the default key to the log drive. Some methods described also include a method of processing logs by an originator. Systems and computer program products are also provided.

### BACKGROUND

An air-gapped log drive is used for storing logs generated by an “originator” device (e.g., an automotive electronic control unit (ECU)). The term “air-gapped” means the log the storage device is “offline” and thus cannot be accessed through a wired or wireless network connection. Because the log drive is “offline,” the log data stored on the log drive cannot be infected or corrupted by a remote actor. Periodically, or after critical events, the log drive can be accessed by an authorized “data processor” (e.g., a log ingestion system) for long term storage or analysis. To assure confidentiality of the log data, the log drive is encrypted. The originator(s) and data processor(s) need to share access to the log drive to allow use of the log data. Typical approaches share the same access credentials across both originator(s) and data processor(s) and at every originator, or use passwords which are best suited for use by humans. In the former case, compromising the access credentials of a data processor or originator exposes the log data on other data processors and originators that use the same access credentials for the log drive.

### BRIEF DESCRIPTION OF THE FIGURES

FIG. 1 is an example environment in which a vehicle including one or more components of an autonomous system can be implemented;

FIG. 2 is a diagram of one or more systems of a vehicle including an autonomous system;

FIG. 3 is a diagram of components of one or more devices and/or one or more systems of FIGS. 1 and 2;

FIG. 4 is a diagram of certain components of an autonomous system;

FIG. 5 is a diagram illustrating log drive initialization by a data processor;

FIG. 6 is a diagram illustrating a process where an originator mounts a log drive and starts logging;

FIG. 7 is a diagram illustrating log ingestion by a data processor;

FIG. 8 is a data flow diagram for a system for protecting confidentiality of air-gapped logs;

FIG. 9 is a flow diagram of a process for protecting confidentiality of air-gapped logs performed by a data processor; and

FIG. 10 is a flow diagram of a process for protecting confidentiality of air-gapped logs performed by an originator, according to one or more embodiments.

### DETAILED DESCRIPTION

In the following description numerous specific details are set forth in order to provide a thorough understanding of the present disclosure for the purposes of explanation. It will be apparent, however, that the embodiments described by the present disclosure can be practiced without these specific details. In some instances, well-known structures and devices are illustrated in block diagram form in order to avoid unnecessarily obscuring aspects of the present disclosure.

Specific arrangements or orderings of schematic elements, such as those representing systems, devices, modules, instruction blocks, data elements, and/or the like are illustrated in the drawings for ease of description. However, it will be understood by those skilled in the art that the specific ordering or arrangement of the schematic elements in the drawings is not meant to imply that a particular order or sequence of processing, or separation of processes, is required unless explicitly described as such. Further, the inclusion of a schematic element in a drawing is not meant to imply that such element is required in all embodiments or that the features represented by such element may not be included in or combined with other elements in some embodiments unless explicitly described as such.

Further, where connecting elements such as solid or dashed lines or arrows are used in the drawings to illustrate a connection, relationship, or association between or among two or more other schematic elements, the absence of any such connecting elements is not meant to imply that no connection, relationship, or association can exist. In other words, some connections, relationships, or associations between elements are not illustrated in the drawings so as not to obscure the disclosure. In addition, for ease of illustration, a single connecting element can be used to represent multiple connections, relationships or associations between elements. For example, where a connecting element represents communication of signals, data, or instructions (e.g., “software instructions”), it should be understood by those skilled in the art that such element can represent one or multiple signal paths (e.g., a bus), as may be needed, to affect the communication.

Although the terms first, second, third, and/or the like are used to describe various elements, these elements should not be limited by these terms. The terms first, second, third, and/or the like are used only to distinguish one element from another. For example, a first contact could be termed a second contact and, similarly, a second contact could be termed a first contact without departing from the scope of the described embodiments. The first contact and the second contact are both contacts, but they are not the same contact.

The terminology used in the description of the various described embodiments herein is included for the purpose of describing particular embodiments only and is not intended to be limiting. As used in the description of the various described embodiments and the appended claims, the singular forms “a,” “an” and “the” are intended to include the plural forms as well and can be used interchangeably with “one or more” or “at least one,” unless the context clearly indicates otherwise. It will also be understood that the term “and/or” as used herein refers to and encompasses any and all possible combinations of one or more of the associated listed items. It will be further understood that the terms “includes,” “including,” “comprises,” and/or “comprising,” when used in this description specify the presence of stated features, integers, steps, operations, elements, and/or components, but do not preclude the presence or addition of one or more other features, integers, steps, operations, elements, components, and/or groups thereof.

As used herein, the terms “communication” and “communicate” refer to at least one of the reception, receipt, transmission, transfer, provision, and/or the like of information (or information represented by, for example, data, signals, messages, instructions, commands, and/or the like). For one unit (e.g., a device, a system, a component of a device or system, combinations thereof, and/or the like) to be in communication with another unit means that the one unit is able to directly or indirectly receive information from and/or send (e.g., transmit) information to the other unit. This may refer to a direct or indirect connection that is wired and/or wireless in nature. Additionally, two units may be in communication with each other even though the information transmitted may be modified, processed, relayed, and/or routed between the first and second unit. For example, a first unit may be in communication with a second unit even though the first unit passively receives information and does not actively transmit information to the second unit. As another example, a first unit may be in communication with a second unit if at least one intermediary unit (e.g., a third unit located between the first unit and the second unit) processes information received from the first unit and transmits the processed information to the second unit. In some embodiments, a message may refer to a network packet (e.g., a data packet and/or the like) that includes data.

As used herein, the term “if” is, optionally, construed to mean “when”, “upon”, “in response to determining,” “in response to detecting,” and/or the like, depending on the context. Similarly, the phrase “if it is determined” or “if [a stated condition or event] is detected” is, optionally, construed to mean “upon determining,” “in response to determining,” “upon detecting [the stated condition or event],” “in response to detecting [the stated condition or event],” and/or the like, depending on the context. Also, as used herein, the terms “has”, “have”, “having”, or the like are intended to be open-ended terms. Further, the phrase “based on” is intended to mean “based at least partially on” unless explicitly stated otherwise.

Reference will now be made in detail to embodiments, examples of which are illustrated in the accompanying drawings. In the following detailed description, numerous specific details are set forth in order to provide a thorough understanding of the various described embodiments. However, it will be apparent to one of ordinary skill in the art that the various described embodiments can be practiced without these specific details. In other instances, well-known methods, procedures, components, circuits, and networks have not been described in detail so as not to unnecessarily obscure aspects of the embodiments.

General Overview

In some aspects and/or embodiments, systems, methods, and computer program products described herein include and/or implement technology that protects confidentiality of air-gapped logs during drive initialization, log collection, and processing.

In an embodiment, during a first log processing cycle of a log ingestion system, a data processor key and a drive encryption key are obtained from storage or generated by a secure hardware. In other embodiments, the data processor key is also stored in secure hardware or wrapped by secure hardware and stored on a non-secured storage device or database. The data processor key and the drive encryption key are unique to a log drive (e.g., a hard disk) mounted to at least one computer processor (e.g., log drive added to OS file system running on computer processor). The drive encryption key is wrapped (e.g., encrypt cryptographic key material with a key encapsulated by secure hardware) with the data processor key and stored in a database that is mapped to data uniquely identifying the log drive. The drive encryption key is wrapped with a default key that is known to at least one originator device (e.g., an automotive ECU) and the log drive is wiped (e.g., contents erased). The wrapped drive encryption key is written to the log drive.

In an embodiment, the drive encryption key and the data processor key are changed each time the log drive is reinitialized.

In an embodiment, during a second log processing cycle following the first log processing cycle, the data processor key and the drive encryption key are replaced by a new data processor key and a new drive encryption key, and the database is updated with the new drive encryption key wrapped by the new data processor key.

In an embodiment, the data processor key and the drive encryption key are generated in secure hardware.

In an embodiment, the identifier is a unique identifier (ID) or serial number of the log drive.

In an embodiment, there are two or more originator devices and a unique default key is known to each originator device

In an embodiment, a method comprises: obtaining, with at least one computer processor, a wrapped drive encryption key; loading, with the at least one computer processor, the wrapped drive encryption key into secure hardware; unwrapping, with the at least one computer processor, the drive encryption key with a default key; generating, with the at least one computer processor, an originator key; wrapping, with the at least one computer processor, the drive encryption key with the originator key; erasing, with the at least one computer processor, a partition of the log drive with the drive encryption key; encrypting, with the at least one computer processor, the partition of the log drive with the drive encryption key; and appending, with the at least one computer processor, data to at least one log in the partition on the encrypted log drive.

In an embodiment, the method further comprises: periodically or upon a predefined event, mounting the log drive on the computer processor; fetching, with the at least one computer processor, the wrapped drive encryption key from a database; unwrapping, with the at least one computer processor, the drive encryption key; decrypting, with the at least one computer processor, the partition on the log drive using the drive encryption key; and retrieving, with the at least one computer processor, log data from the partition.

In an embodiment, the computer processor re-initializes the log drive.

In an embodiment, the mounting of the log drive to the computer processor is performed by a trusted operator in a controlled environment.

In an embodiment, the originator key is generated in secure hardware.

In an embodiment, the partition is erased and encrypted with a second drive encryption key derived from the drive encryption key.

By virtue of the implementation of systems, methods, and computer program products described herein, techniques for protecting confidentiality of air-gapped logs provide at least the following advantages. The techniques allow multiple entities to share access to log data across an air gap while maintaining confidentiality. The techniques are useful, for example, to centralize storage and processing of “black box” logs collected across a fleet of vehicles, and also allows for scalable management of logs across the fleet. Thus, the disclosed techniques provide advantages over conventional techniques of protecting air-gapped logs that share the same credentials across multiple entities, or use passwords that are better suited for use by humans. If credentials are shared, then compromising the credentials on one entity (e.g., a vehicle) will expose the log data on other entities using the same credentials.

The log drive can be used on any originator that supports the same encryption sharing mechanism reducing logistical complexity. Each data processing entity involved in the log processing can use its own access credentials to seal the log drive encryption key, without exposing the shared secret (i.e., the drive encryption key). Only a default key (described below) is shared between the entities. After an originator mounts the log drive for the first time, only the originator and data processor can access the log data, which reduces the attack surface.

The disclosed techniques can be used in most embedded applications that require confidentiality while sharing persistent data across an air gap, such as between automotive ECUs and log ingestion station.

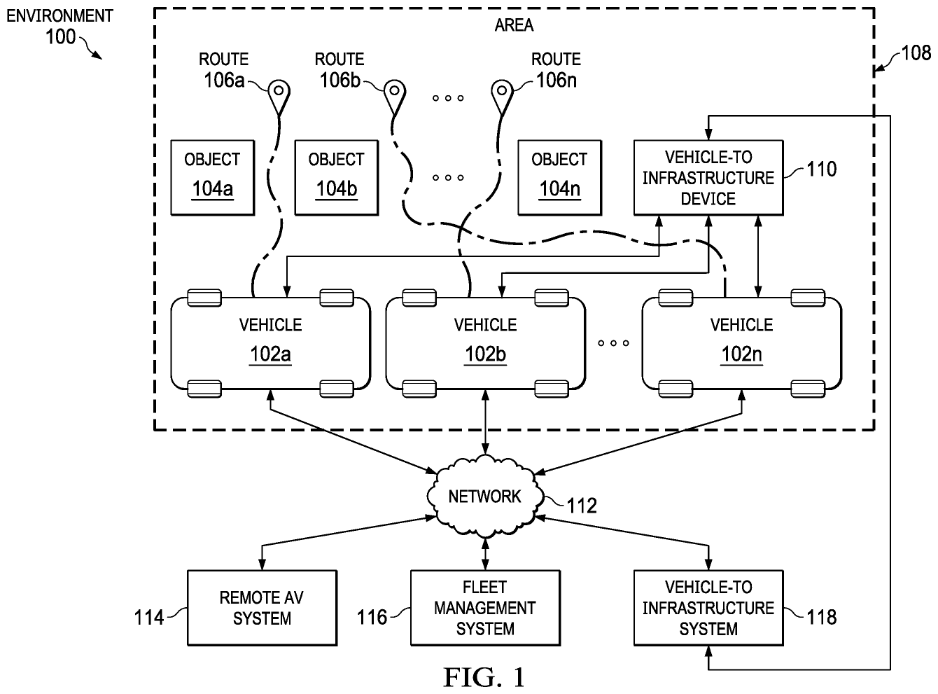

Referring now to FIG. 1, illustrated is example environment 100 in which vehicles that include autonomous systems, as well as vehicles that do not, are operated. As illustrated, environment 100 includes vehicles 102a-102n, objects 104a-104n, routes 106a-106n, area 108, vehicle-to-infrastructure (V2I) device 110, network 112, remote autonomous vehicle (AV) system 114, fleet management system 116, and V2I system 118. Vehicles 102a-102n, vehicle-to-infrastructure (V2I) device 110, network 112, autonomous vehicle (AV) system 114, fleet management system 116, and V2I system 118 interconnect (e.g., establish a connection to communicate and/or the like) via wired connections, wireless connections, or a combination of wired or wireless connections. In some embodiments, objects 104a-104n interconnect with at least one of vehicles 102a-102n, vehicle-to-infrastructure (V2I) device 110, network 112, autonomous vehicle (AV) system 114, fleet management system 116, and V2I system 118 via wired connections, wireless connections, or a combination of wired or wireless connections.

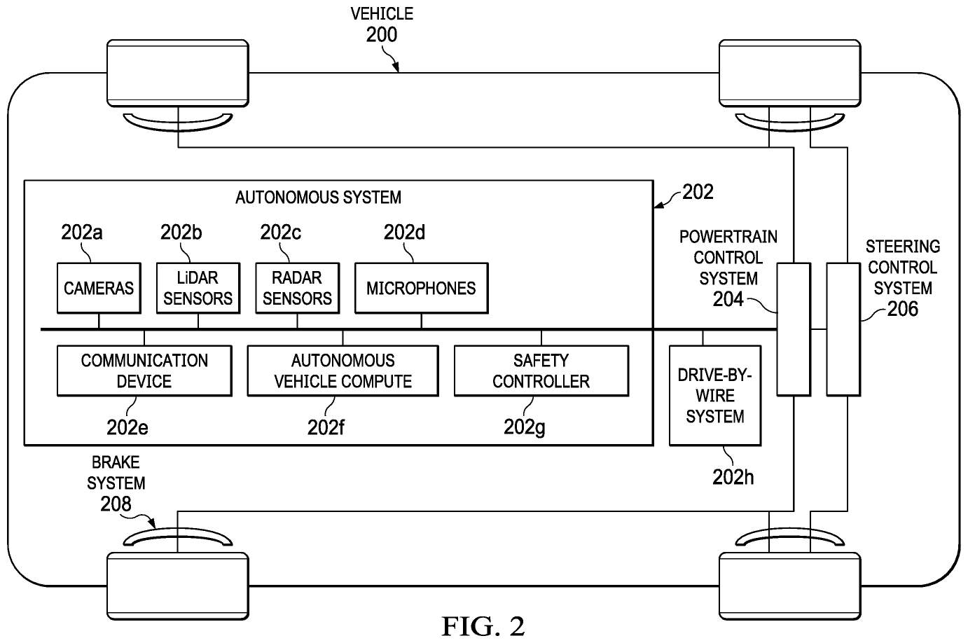

Vehicles 102a-104n (referred to individually as vehicle 102 and collectively as vehicles 102) include at least one device configured to transport goods and/or people. In some embodiments, vehicles 102 are configured to be in communication with V2I device 110, remote AV system 114, fleet management system 116, and/or V2I system 118 via network 112. In some embodiments, vehicles 102 include cars, buses, trucks, trains, and/or the like. In some embodiments, vehicles 102 are the same as, or similar to, vehicles 200, described herein (see FIG. 2). In some embodiments, a vehicle 200 of a set of vehicles 200 is associated with an autonomous fleet manager. In some embodiments, vehicles 102 travel along respective routes 106a-106n (referred to individually as route 106 and collectively as routes 106), as described herein. In some embodiments, one or more vehicles 102 include an autonomous system (e.g., an autonomous system that is the same as or similar to autonomous system 202).

Objects 104a-104n (referred to individually as object 104 and collectively as objects 104) include, for example, at least one vehicle, at least one pedestrian, at least one cyclist, at least one structure (e.g., a building, a sign, a fire hydrant, etc.), and/or the like. Each object 104 is stationary (e.g., located at a fixed location for a period of time) or mobile (e.g., having a velocity and associated with at least one trajectory). In some embodiments, objects 104 are associated with corresponding locations in area 108.

Routes 106a-106n (referred to individually as route 106 and collectively as routes 106) are each associated with (e.g., prescribe) a sequence of actions (also known as a trajectory) connecting states along which an AV can navigate. Each route 106 starts at an initial state (e.g., a state that corresponds to a first spatiotemporal location, velocity, and/or the like) and a final goal state (e.g., a state that corresponds to a second spatiotemporal location that is different from the first spatiotemporal location) or goal region (e.g. a subspace of acceptable states (e.g., terminal states)). In some embodiments, the first state includes a location at which an individual or individuals are to be picked-up by the AV and the second state or region includes a location or locations at which the individual or individuals picked-up by the AV are to be dropped-off. In some embodiments, routes 106 include a plurality of acceptable state sequences (e.g., a plurality of spatiotemporal location sequences), the plurality of state sequences associated with (e.g., defining) a plurality of trajectories. In an example, routes 106 include only high level actions or imprecise state locations, such as a series of connected roads dictating turning directions at roadway intersections. Additionally, or alternatively, routes 106 may include more precise actions or states such as, for example, specific target lanes or precise locations within the lane areas and targeted speed at those positions. In an example, routes 106 include a plurality of precise state sequences along the at least one high level action sequence with a limited lookahead horizon to reach intermediate goals, where the combination of successive iterations of limited horizon state sequences cumulatively correspond to a plurality of trajectories that collectively form the high level route to terminate at the final goal state or region.

Area 108 includes a physical area (e.g., a geographic region) within which vehicles 102 can navigate. In an example, area 108 includes at least one state (e.g., a country, a province, an individual state of a plurality of states included in a country, etc.), at least one portion of a state, at least one city, at least one portion of a city, etc. In some embodiments, area 108 includes at least one named thoroughfare (referred to herein as a “road”) such as a highway, an interstate highway, a parkway, a city street, etc. Additionally, or alternatively, in some examples area 108 includes at least one unnamed road such as a driveway, a section of a parking lot, a section of a vacant and/or undeveloped lot, a dirt path, etc. In some embodiments, a road includes at least one lane (e.g., a portion of the road that can be traversed by vehicles 102). In an example, a road includes at least one lane associated with (e.g., identified based on) at least one lane marking.

Vehicle-to-Infrastructure (V2I) device 110 (sometimes referred to as a Vehicle-to-Infrastructure (V2X) device) includes at least one device configured to be in communication with vehicles 102 and/or V2I infrastructure system 118. In some embodiments, V2I device 110 is configured to be in communication with vehicles 102, remote AV system 114, fleet management system 116, and/or V2I system 118 via network 112. In some embodiments, V2I device 110 includes a radio frequency identification (RFID) device, signage, cameras (e.g., two-dimensional (2D) and/or three-dimensional (3D) cameras), lane markers, streetlights, parking meters, etc. In some embodiments, V2I device 110 is configured to communicate directly with vehicles 102. Additionally, or alternatively, in some embodiments V2I device 110 is configured to communicate with vehicles 102, remote AV system 114, and/or fleet management system 116 via V2I system 118. In some embodiments, V2I device 110 is configured to communicate with V2I system 118 via network 112.

Network 112 includes one or more wired and/or wireless networks. In an example, network 112 includes a cellular network (e.g., a long term evolution (LTE) network, a third generation (3G) network, a fourth generation (4G) network, a fifth generation (5G) network, a code division multiple access (CDMA) network, etc.), a public land mobile network (PLMN), a local area network (LAN), a wide area network (WAN), a metropolitan area network (MAN), a telephone network (e.g., the public switched telephone network (PSTN), a private network, an ad hoc network, an intranet, the Internet, a fiber optic-based network, a cloud computing network, etc., a combination of some or all of these networks, and/or the like.

Remote AV system 114 includes at least one device configured to be in communication with vehicles 102, V2I device 110, network 112, remote AV system 114, fleet management system 116, and/or V2I system 118 via network 112. In an example, remote AV system 114 includes a server, a group of servers, and/or other like devices. In some embodiments, remote AV system 114 is co-located with the fleet management system 116. In some embodiments, remote AV system 114 is involved in the installation of some or all of the components of a vehicle, including an autonomous system, an autonomous vehicle compute, software implemented by an autonomous vehicle compute, and/or the like. In some embodiments, remote AV system 114 maintains (e.g., updates and/or replaces) such components and/or software during the lifetime of the vehicle.

Fleet management system 116 includes at least one device configured to be in communication with vehicles 102, V2I device 110, remote AV system 114, and/or V2I infrastructure system 118. In an example, fleet management system 116 includes a server, a group of servers, and/or other like devices. In some embodiments, fleet management system 116 is associated with a ridesharing company (e.g., an organization that controls operation of multiple vehicles (e.g., vehicles that include autonomous systems and/or vehicles that do not include autonomous systems) and/or the like).

In some embodiments, V2I system 118 includes at least one device configured to be in communication with vehicles 102, V2I device 110, remote AV system 114, and/or fleet management system 116 via network 112. In some examples, V2I system 118 is configured to be in communication with V2I device 110 via a connection different from network 112. In some embodiments, V2I system 118 includes a server, a group of servers, and/or other like devices. In some embodiments, V2I system 118 is associated with a municipality or a private institution (e.g., a private institution that maintains V2I device 110 and/or the like).

The number and arrangement of elements illustrated in FIG. 1 are provided as an example. There can be additional elements, fewer elements, different elements, and/or differently arranged elements, than those illustrated in FIG. 1. Additionally, or alternatively, at least one element of environment 100 can perform one or more functions described as being performed by at least one different element of FIG. 1. Additionally, or alternatively, at least one set of elements of environment 100 can perform one or more functions described as being performed by at least one different set of elements of environment 100.

Referring now to FIG. 2, vehicle 200 includes autonomous system 202, powertrain control system 204, steering control system 206, and brake system 208. In some embodiments, vehicle 200 is the same as or similar to vehicle 102 (see FIG. 1). In some embodiments, vehicle 102 have autonomous capability (e.g., implement at least one function, feature, device, and/or the like that enable vehicle 200 to be partially or fully operated without human intervention including, without limitation, fully autonomous vehicles (e.g., vehicles that forego reliance on human intervention), highly autonomous vehicles (e.g., vehicles that forego reliance on human intervention in certain situations), and/or the like). For a detailed description of fully autonomous vehicles and highly autonomous vehicles, reference may be made to SAE International's standard J3016: Taxonomy and Definitions for Terms Related to On-Road Motor Vehicle Automated Driving Systems, which is incorporated by reference in its entirety. In some embodiments, vehicle 200 is associated with an autonomous fleet manager and/or a ridesharing company.

Autonomous system 202 includes a sensor suite that includes one or more devices such as cameras 202a, LiDAR sensors 202b, radar sensors 202c, and microphones 202d. In some embodiments, autonomous system 202 can include more or fewer devices and/or different devices (e.g., ultrasonic sensors, inertial sensors, GPS receivers (discussed below), odometry sensors that generate data associated with an indication of a distance that vehicle 200 has traveled, and/or the like). In some embodiments, autonomous system 202 uses the one or more devices included in autonomous system 202 to generate data associated with environment 100, described herein. The data generated by the one or more devices of autonomous system 202 can be used by one or more systems described herein to observe the environment (e.g., environment 100) in which vehicle 200 is located. In some embodiments, autonomous system 202 includes communication device 202e, autonomous vehicle compute 202f, and drive-by-wire (DBW) system 202h.

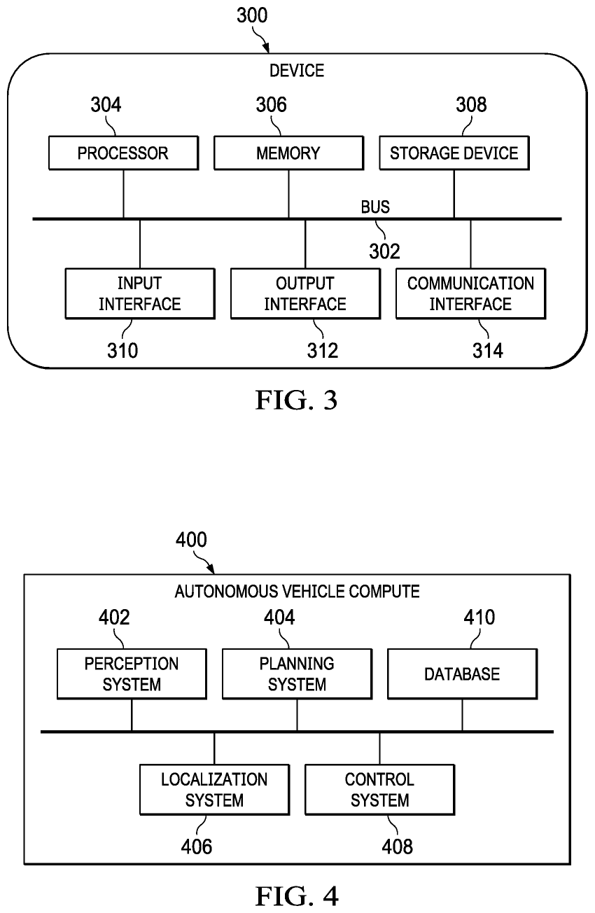

Cameras 202a include at least one device configured to be in communication with communication device 202e, autonomous vehicle compute 202f, and/or safety controller 202g via a bus (e.g., a bus that is the same as or similar to bus 302 of FIG. 3). Cameras 202a include at least one camera (e.g., a digital camera using a light sensor such as a charge-coupled device (CCD), a thermal camera, an infrared (IR) camera, an event camera, and/or the like) to capture images including physical objects (e.g., cars, buses, curbs, people, and/or the like). In some embodiments, camera 202a generates camera data as output. In some examples, camera 202a generates camera data that includes image data associated with an image. In this example, the image data may specify at least one parameter (e.g., image characteristics such as exposure, brightness, etc., an image timestamp, and/or the like) corresponding to the image. In such an example, the image may be in a format (e.g., RAW, JPEG, PNG, and/or the like). In some embodiments, camera 202a includes a plurality of independent cameras configured on (e.g., positioned on) a vehicle to capture images for the purpose of stereopsis (stereo vision). In some examples, camera 202a includes a plurality of cameras that generate image data and transmit the image data to autonomous vehicle compute 202f and/or a fleet management system (e.g., a fleet management system that is the same as or similar to fleet management system 116 of FIG. 1). In such an example, autonomous vehicle compute 202f determines depth to one or more objects in a field of view of at least two cameras of the plurality of cameras based on the image data from the at least two cameras. In some embodiments, cameras 202a is configured to capture images of objects within a distance from cameras 202a (e.g., up to 100 meters, up to a kilometer, and/or the like). Accordingly, cameras 202a include features such as sensors and lenses that are optimized for perceiving objects that are at one or more distances from cameras 202a.

In an embodiment, camera 202a includes at least one camera configured to capture one or more images associated with one or more traffic lights, street signs and/or other physical objects that provide visual navigation information. In some embodiments, camera 202a generates traffic light data associated with one or more images. In some examples, camera 202a generates TLD data associated with one or more images that include a format (e.g., RAW, JPEG, PNG, and/or the like). In some embodiments, camera 202a that generates TLD data differs from other systems described herein incorporating cameras in that camera 202a can include one or more cameras with a wide field of view (e.g., a wide-angle lens, a fish-eye lens, a lens having a viewing angle of approximately 120 degrees or more, and/or the like) to generate images about as many physical objects as possible.

Laser Detection and Ranging (LiDAR) sensors 202b include at least one device configured to be in communication with communication device 202e, autonomous vehicle compute 202f, and/or safety controller 202g via a bus (e.g., a bus that is the same as or similar to bus 302 of FIG. 3). LiDAR sensors 202b include a system configured to transmit light from a light emitter (e.g., a laser transmitter). Light emitted by LiDAR sensors 202b include light (e.g., infrared light and/or the like) that is outside of the visible spectrum. In some embodiments, during operation, light emitted by LiDAR sensors 202b encounters a physical object (e.g., a vehicle) and is reflected back to LiDAR sensors 202b. In some embodiments, the light emitted by LiDAR sensors 202b does not penetrate the physical objects that the light encounters. LiDAR sensors 202b also include at least one light detector which detects the light that was emitted from the light emitter after the light encounters a physical object. In some embodiments, at least one data processing system associated with LiDAR sensors 202b generates an image (e.g., a point cloud, a combined point cloud, and/or the like) representing the objects included in a field of view of LiDAR sensors 202b. In some examples, the at least one data processing system associated with LiDAR sensor 202b generates an image that represents the boundaries of a physical object, the surfaces (e.g., the topology of the surfaces) of the physical object, and/or the like. In such an example, the image is used to determine the boundaries of physical objects in the field of view of LiDAR sensors 202b.

Radio Detection and Ranging (radar) sensors 202c include at least one device configured to be in communication with communication device 202e, autonomous vehicle compute 202f, and/or safety controller 202g via a bus (e.g., a bus that is the same as or similar to bus 302 of FIG. 3). Radar sensors 202c include a system configured to transmit radio waves (either pulsed or continuously). The radio waves transmitted by radar sensors 202c include radio waves that are within a predetermined spectrum In some embodiments, during operation, radio waves transmitted by radar sensors 202c encounter a physical object and are reflected back to radar sensors 202c. In some embodiments, the radio waves transmitted by radar sensors 202c are not reflected by some objects. In some embodiments, at least one data processing system associated with radar sensors 202c generates signals representing the objects included in a field of view of radar sensors 202c. For example, the at least one data processing system associated with radar sensor 202c generates an image that represents the boundaries of a physical object, the surfaces (e.g., the topology of the surfaces) of the physical object, and/or the like. In some examples, the image is used to determine the boundaries of physical objects in the field of view of radar sensors 202c.

Microphones 202d includes at least one device configured to be in communication with communication device 202e, autonomous vehicle compute 202f, and/or safety controller 202g via a bus (e.g., a bus that is the same as or similar to bus 302 of FIG. 3). Microphones 202d include one or more microphones (e.g., array microphones, external microphones, and/or the like) that capture audio signals and generate data associated with (e.g., representing) the audio signals. In some examples, microphones 202d include transducer devices and/or like devices. In some embodiments, one or more systems described herein can receive the data generated by microphones 202d and determine a position of an object relative to vehicle 200 (e.g., a distance and/or the like) based on the audio signals associated with the data.

Communication device 202e include at least one device configured to be in communication with cameras 202a, LiDAR sensors 202b, radar sensors 202c, microphones 202d, autonomous vehicle compute 202f, safety controller 202g, and/or DBW system 202h. For example, communication device 202e may include a device that is the same as or similar to communication interface 314 of FIG. 3. In some embodiments, communication device 202e includes a vehicle-to-vehicle (V2V) communication device (e.g., a device that enables wireless communication of data between vehicles).

Autonomous vehicle compute 202f include at least one device configured to be in communication with cameras 202a, LiDAR sensors 202b, radar sensors 202c, microphones 202d, communication device 202e, safety controller 202g, and/or DBW system 202h. In some examples, autonomous vehicle compute 202f includes a device such as a client device, a mobile device (e.g., a cellular telephone, a tablet, and/or the like) a server (e.g., a computing device including one or more central processing units, graphical processing units, and/or the like), and/or the like. In some embodiments, autonomous vehicle compute 202f is the same as or similar to autonomous vehicle compute 400, described herein. Additionally, or alternatively, in some embodiments autonomous vehicle compute 202f is configured to be in communication with an autonomous vehicle system (e.g., an autonomous vehicle system that is the same as or similar to remote AV system 114 of FIG. 1), a fleet management system (e.g., a fleet management system that is the same as or similar to fleet management system 116 of FIG. 1), a V2I device (e.g., a V2I device that is the same as or similar to V2I device 110 of FIG. 1), and/or a V2I system (e.g., a V2I system that is the same as or similar to V2I system 118 of FIG. 1).

Safety controller 202g includes at least one device configured to be in communication with cameras 202a, LiDAR sensors 202b, radar sensors 202c, microphones 202d, communication device 202e, autonomous vehicle computer 202f, and/or DBW system 202h. In some examples, safety controller 202g includes one or more controllers (electrical controllers, electromechanical controllers, and/or the like) that are configured to generate and/or transmit control signals to operate one or more devices of vehicle 200 (e.g., powertrain control system 204, steering control system 206, brake system 208, and/or the like). In some embodiments, safety controller 202g is configured to generate control signals that take precedence over (e.g., overrides) control signals generated and/or transmitted by autonomous vehicle compute 202f.

DBW system 202h includes at least one device configured to be in communication with communication device 202e and/or autonomous vehicle compute 202f. In some examples, DBW system 202h includes one or more controllers (e.g., electrical controllers, electromechanical controllers, and/or the like) that are configured to generate and/or transmit control signals to operate one or more devices of vehicle 200 (e.g., powertrain control system 204, steering control system 206, brake system 208, and/or the like). Additionally, or alternatively, the one or more controllers of DBW system 202h are configured to generate and/or transmit control signals to operate at least one different device (e.g., a turn signal, headlights, door locks, windshield wipers, and/or the like) of vehicle 200.

Powertrain control system 204 includes at least one device configured to be in communication with DBW system 202h. In some examples, powertrain control system 204 includes at least one controller, actuator, and/or the like. In some embodiments, powertrain control system 204 receives control signals from DBW system 202h and powertrain control system 204 causes vehicle 200 to start moving forward, stop moving forward, start moving backward, stop moving backward, accelerate in a direction, decelerate in a direction, perform a left turn, perform a right turn, and/or the like. In an example, powertrain control system 204 causes the energy (e.g., fuel, electricity, and/or the like) provided to a motor of the vehicle to increase, remain the same, or decrease, thereby causing at least one wheel of vehicle 200 to rotate or not rotate.

Steering control system 206 includes at least one device configured to rotate one or more wheels of vehicle 200. In some examples, steering control system 206 includes at least one controller, actuator, and/or the like. In some embodiments, steering control system 206 causes the front two wheels and/or the rear two wheels of vehicle 200 to rotate to the left or right to cause vehicle 200 to turn to the left or right.

Brake system 208 includes at least one device configured to actuate one or more brakes to cause vehicle 200 to reduce speed and/or remain stationary. In some examples, brake system 208 includes at least one controller and/or actuator that is configured to cause one or more calipers associated with one or more wheels of vehicle 200 to close on a corresponding rotor of vehicle 200. Additionally, or alternatively, in some examples brake system 208 includes an automatic emergency braking (AEB) system, a regenerative braking system, and/or the like.

In some embodiments, vehicle 200 includes at least one platform sensor (not explicitly illustrated) that measures or infers properties of a state or a condition of vehicle 200. In some examples, vehicle 200 includes platform sensors such as a global positioning system (GPS) receiver, an inertial measurement unit (IMU), a wheel speed sensor, a wheel brake pressure sensor, a wheel torque sensor, an engine torque sensor, a steering angle sensor, and/or the like.

Referring now to FIG. 3, illustrated is a schematic diagram of a device 300. As illustrated, device 300 includes computer processor 304, memory 306, storage component 308, input interface 310, output interface 312, communication interface 314, and bus 302. In some embodiments, device 300 corresponds to at least one device of vehicles 102 (e.g., at least one device of a system of vehicles 102), at least one device of, and/or one or more devices of network 112 (e.g., one or more devices of a system of network 112). In some embodiments, one or more devices of vehicles 102 (e.g., one or more devices of a system of vehicles 102), and/or one or more devices of network 112 (e.g., one or more devices of a system of network 112) include at least one device 300 and/or at least one component of device 300. As shown in FIG. 3, device 300 includes bus 302, computer processor 304, memory 306, storage component 308, input interface 310, output interface 312, and communication interface 314.

Bus 302 includes a component that permits communication among the components of device 300. In some embodiments, computer processor 304 is implemented in hardware, software, or a combination of hardware and software. In some examples, computer processor 304 includes a computer processor (e.g., a central processing unit (CPU), a graphics processing unit (GPU), an accelerated processing unit (APU), and/or the like), a microphone, a digital signal processor (DSP), and/or any processing component (e.g., a field-programmable gate array (FPGA), an application specific integrated circuit (ASIC), and/or the like) that can be programmed to perform at least one function. Memory 306 includes random access memory (RAM), read-only memory (ROM), and/or another type of dynamic and/or static storage device (e.g., flash memory, magnetic memory, optical memory, and/or the like) that stores data and/or instructions for use by computer processor 304.

Storage component 308 stores data and/or software related to the operation and use of device 300. In some examples, storage component 308 includes a hard disk (e.g., a magnetic disk, an optical disk, a magneto-optic disk, a solid state disk, and/or the like), a compact disc (CD), a digital versatile disc (DVD), a floppy disk, a cartridge, a magnetic tape, a CD-ROM, RAM, PROM, EPROM, FLASH-EPROM, NV-RAM, and/or another type of computer readable medium, along with a corresponding drive.

Input interface 310 includes a component that permits device 300 to receive information, such as via user input (e.g., a touchscreen display, a keyboard, a keypad, a mouse, a button, a switch, a microphone, a camera, and/or the like). Additionally or alternatively, in some embodiments input interface 310 includes a sensor that senses information (e.g., a global positioning system (GPS) receiver, an accelerometer, a gyroscope, an actuator, and/or the like). Output interface 312 includes a component that provides output information from device 300 (e.g., a display, a speaker, one or more light-emitting diodes (LEDs), and/or the like).

In some embodiments, communication interface 314 includes a transceiver-like component (e.g., a transceiver, a separate receiver and transmitter, and/or the like) that permits device 300 to communicate with other devices via a wired connection, a wireless connection, or a combination of wired and wireless connections. In some examples, communication interface 314 permits device 300 to receive information from another device and/or provide information to another device. In some examples, communication interface 314 includes an Ethernet interface, an optical interface, a coaxial interface, an infrared interface, a radio frequency (RF) interface, a universal serial bus (USB) interface, a Wi-Fi® interface, a cellular network interface, and/or the like.

In some embodiments, device 300 performs one or more processes described herein. Device 300 performs these processes based on computer processor 304 executing software instructions stored by a computer-readable medium, such as memory 305 and/or storage component 308. A computer-readable medium (e.g., a non-transitory computer readable medium) is defined herein as a non-transitory memory device. A non-transitory memory device includes memory space located inside a single physical storage device or memory space spread across multiple physical storage devices.

In some embodiments, software instructions are read into memory 306 and/or storage component 308 from another computer-readable medium or from another device via communication interface 314. When executed, software instructions stored in memory 306 and/or storage component 308 cause computer processor 304 to perform one or more processes described herein. Additionally or alternatively, hardwired circuitry is used in place of or in combination with software instructions to perform one or more processes described herein. Thus, embodiments described herein are not limited to any specific combination of hardware circuitry and software unless explicitly stated otherwise.

Memory 306 and/or storage component 308 includes data storage or at least one data structure (e.g., a database and/or the like). Device 300 is capable of receiving information from, storing information in, communicating information to, or searching information stored in the data storage or the at least one data structure in memory 306 or storage component 308. In some examples, the information includes network data, input data, output data, or any combination thereof.

In some embodiments, device 300 is configured to execute software instructions that are either stored in memory 306 and/or in the memory of another device (e.g., another device that is the same as or similar to device 300). As used herein, the term “module” refers to at least one instruction stored in memory 306 and/or in the memory of another device that, when executed by computer processor 304 and/or by a computer processor of another device (e.g., another device that is the same as or similar to device 300) cause device 300 (e.g., at least one component of device 300) to perform one or more processes described herein. In some embodiments, a module is implemented in software, firmware, hardware, and/or the like.

The number and arrangement of components illustrated in FIG. 3 are provided as an example. In some embodiments, device 300 can include additional components, fewer components, different components, or differently arranged components than those illustrated in FIG. 3. Additionally or alternatively, a set of components (e.g., one or more components) of device 300 can perform one or more functions described as being performed by another component or another set of components of device 300.

Referring now to FIG. 4A, illustrated is an example block diagram of an autonomous vehicle compute 400 (sometimes referred to as an “AV stack”). As illustrated, autonomous vehicle compute 400 includes perception system 402 (sometimes referred to as a perception module), planning system 404 (sometimes referred to as a planning module), localization system 406 (sometimes referred to as a localization module), control system 408 (sometimes referred to as a control module), and database 410. In some embodiments, perception system 402, planning system 404, localization system 406, control system 408, and database 410 are included and/or implemented in an autonomous navigation system of a vehicle (e.g., autonomous vehicle compute 202f of vehicle 200). Additionally, or alternatively, in some embodiments perception system 402, planning system 404, localization system 406, control system 408, and database 410 are included in one or more standalone systems (e.g., one or more systems that are the same as or similar to autonomous vehicle compute 400 and/or the like). In some examples, perception system 402, planning system 404, localization system 406, control system 408, and database 410 are included in one or more standalone systems that are located in a vehicle and/or at least one remote system as described herein. In some embodiments, any and/or all of the systems included in autonomous vehicle compute 400 are implemented in software (e.g., in software instructions stored in memory), computer hardware (e.g., by microprocessors, microcontrollers, application-specific integrated circuits [ASICs], Field Programmable Gate Arrays (FPGAs), and/or the like), or combinations of computer software and computer hardware. It will also be understood that, in some embodiments, autonomous vehicle compute 400 is configured to be in communication with a remote system (e.g., an autonomous vehicle system that is the same as or similar to remote AV system 114, a fleet management system 116 that is the same as or similar to fleet management system 116, a V2I system that is the same as or similar to V2I system 118, and/or the like).

In some embodiments, perception system 402 receives data associated with at least one physical object (e.g., data that is used by perception system 402 to detect the at least one physical object) in an environment and classifies the at least one physical object. In some examples, perception system 402 receives image data captured by at least one camera (e.g., cameras 202a), the image associated with (e.g., representing) one or more physical objects within a field of view of the at least one camera. In such an example, perception system 402 classifies at least one physical object based on one or more groupings of physical objects (e.g., bicycles, vehicles, traffic signs, pedestrians, and/or the like). In some embodiments, perception system 402 transmits data associated with the classification of the physical objects to planning system 404 based on perception system 402 classifying the physical objects.

In some embodiments, planning system 404 receives data associated with a destination and generates data associated with at least one route (e.g., routes 106) along which a vehicle (e.g., vehicles 102) can travel along toward a destination. In some embodiments, planning system 404 periodically or continuously receives data from perception system 402 (e.g., data associated with the classification of physical objects, described above) and planning system 404 updates the at least one trajectory or generates at least one different trajectory based on the data generated by perception system 402. In some embodiments, planning system 404 receives data associated with an updated position of a vehicle (e.g., vehicles 102) from localization system 406 and planning system 404 updates the at least one trajectory or generates at least one different trajectory based on the data generated by localization system 406.

In some embodiments, localization system 406 receives data associated with (e.g., representing) a location of a vehicle (e.g., vehicles 102) in an area. In some examples, localization system 406 receives LiDAR data associated with at least one point cloud generated by at least one LiDAR sensor (e.g., LiDAR sensors 202b). In certain examples, localization system 406 receives data associated with at least one point cloud from multiple LiDAR sensors and localization system 406 generates a combined point cloud based on each of the point clouds. In these examples, localization system 406 compares the at least one point cloud or the combined point cloud to two-dimensional (2D) and/or a three-dimensional (3D) map of the area stored in database 410. Localization system 406 then determines the position of the vehicle in the area based on localization system 406 comparing the at least one point cloud or the combined point cloud to the map. In some embodiments, the map includes a combined point cloud of the area generated prior to navigation of the vehicle. In some embodiments, maps include, without limitation, high-precision maps of the roadway geometric properties, maps describing road network connectivity properties, maps describing roadway physical properties (such as traffic speed, traffic volume, the number of vehicular and cyclist traffic lanes, lane width, lane traffic directions, or lane marker types and locations, or combinations thereof), and maps describing the spatial locations of road features such as crosswalks, traffic signs or other travel signals of various types. In some embodiments, the map is generated in real-time based on the data received by the perception system.

In another example, localization system 406 receives Global Navigation Satellite System (GNSS) data generated by a global positioning system (GPS) receiver. In some examples, localization system 406 receives GNSS data associated with the location of the vehicle in the area and localization system 406 determines a latitude and longitude of the vehicle in the area. In such an example, localization system 406 determines the position of the vehicle in the area based on the latitude and longitude of the vehicle. In some embodiments, localization system 406 generates data associated with the position of the vehicle. In some examples, localization system 406 generates data associated with the position of the vehicle based on localization system 406 determining the position of the vehicle. In such an example, the data associated with the position of the vehicle includes data associated with one or more semantic properties corresponding to the position of the vehicle.

In some embodiments, control system 408 receives data associated with at least one trajectory from planning system 404 and control system 408 controls operation of the vehicle. In some examples, control system 408 receives data associated with at least one trajectory from planning system 404 and control system 408 controls operation of the vehicle by generating and transmitting control signals to cause a powertrain control system (e.g., DBW system 202h, powertrain control system 204, and/or the like), a steering control system (e.g., steering control system 206), and/or a brake system (e.g., brake system 208) to operate. In an example, where a trajectory includes a left turn, control system 408 transmits a control signal to cause steering control system 206 to adjust a steering angle of vehicle 200, thereby causing vehicle 200 to turn left. Additionally, or alternatively, control system 408 generates and transmits control signals to cause other devices (e.g., headlights, turn signal, door locks, windshield wipers, and/or the like) of vehicle 200 to change states.

In some embodiments, perception system 402, planning system 404, localization system 406, and/or control system 408 implement at least one machine learning model (e.g., at least one multilayer perceptron (MLP), at least one convolutional neural network (CNN), at least one recurrent neural network (RNN), at least one autoencoder, at least one transformer, and/or the like). In some examples, perception system 402, planning system 404, localization system 406, and/or control system 408 implement at least one machine learning model alone or in combination with one or more of the above-noted systems. In some examples, perception system 402, planning system 404, localization system 406, and/or control system 408 implement at least one machine learning model as part of a pipeline (e.g., a pipeline for identifying one or more objects located in an environment and/or the like).

Database 410 stores data that is transmitted to, received from, and/or updated by perception system 402, planning system 404, localization system 406 and/or control system 408. In some examples, database 410 includes a storage component (e.g., a storage component that is the same as or similar to storage component 308 of FIG. 3) that stores data and/or software related to the operation and uses at least one system of autonomous vehicle compute 400. In some embodiments, database 410 stores data associated with 2D and/or 3D maps of at least one area. In some examples, database 410 stores data associated with 2D and/or 3D maps of a portion of a city, multiple portions of multiple cities, multiple cities, a county, a state, a State (e.g., a country), and/or the like). In such an example, a vehicle (e.g., a vehicle that is the same as or similar to vehicles 102 and/or vehicle 200) can drive along one or more drivable regions (e.g., single-lane roads, multi-lane roads, highways, back roads, off road trails, and/or the like) and cause at least one LiDAR sensor (e.g., a LiDAR sensor that is the same as or similar to LiDAR sensors 202b) to generate data associated with an image representing the objects included in a field of view of the at least one LiDAR sensor.

In some embodiments, database 410 can be implemented across a plurality of devices. In some examples, database 410 is included in a vehicle (e.g., a vehicle that is the same as or similar to vehicles 102 and/or vehicle 200), an autonomous vehicle system (e.g., an autonomous vehicle system that is the same as or similar to remote AV system 114, a fleet management system (e.g., a fleet management system that is the same as or similar to fleet management system 116 of FIG. 1, a V2I system (e.g., a V2I system that is the same as or similar to V2I system 118 of FIG. 1) and/or the like.

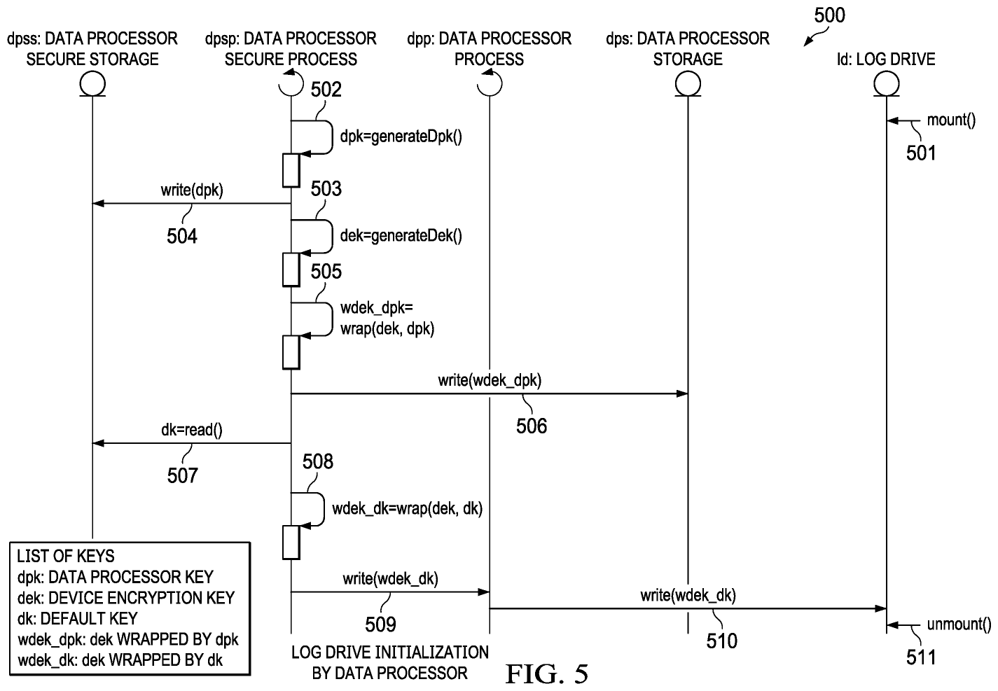

FIG. 5 is a diagram illustrating log drive initialization procedure 500 performed by a data processor, according to one or more embodiments. The data processor is a system that reads log data stored on a log drive. In an embodiment, the data processor can be a computer processor (e.g., computer processor 304) located at a log ingestion station and originator 802 can be an automotive electronic control unit (ECU).

The data processor is responsible for log drive device initialization, and may be the same as, or similar to, one or more devices included in environment 100 and/or vehicle 200 (e.g., one or more computer processors 304 included in one or more devices included in environment 100 and/or vehicle 200).

After mounting the log drive (Id) (501), data processor secure process (dpsp) generates a data processor key (dpk) (502) and a drive encryption key (dek) (503) and writes the data processor key to data processor secure storage (dpss) (504). The data processor key and drive encryption key are generated in secure hardware. Depending on the application, the data processor key and drive encryption key can also be changed each time the log drive is reinitialized, so that any compromise of the device encryption key does not affect the same log drive during a different logging cycle.

Data processor secure process wraps the drive encryption key with the data processor key (505) and writes the wrapped drive encryption key in a database (e.g., database 410) configured in data processor storage (dps) (506), which is mapped to a unique ID or serial number of the log drive. When the data processor key and drive encryption key are replaced on every cycle, the database is also updated with the new wrapped drive encryption key.

Data processor secure process reads the default key (dk) from data processor secure storage (507) and wraps the drive encryption key with a default key (dk) (508), which is known to all relevant originators. In other embodiments, the default key can be wrapped with another key and stored on data processor storage. Although the default key could also be configured uniquely for each originator, such a configuration would increase the complexity of the overall system without making the system more secure against insider attacks. Data processor process (dps) wipes (i.e., erases) the log drive, reads the wrapped drive encryption key from the data processor secure process (509) and writes the drive encryption key wrapped by default key on the log drive (510). The log drive is unmounted (511) from the data processor's computer processor (e.g., unmounted by a file management system and/or operating system) and transferred/mounted to the originator's computer processor by a trusted operator (e.g., a person expected to transfer the log drive without tampering with the log drive) in a controlled environment.

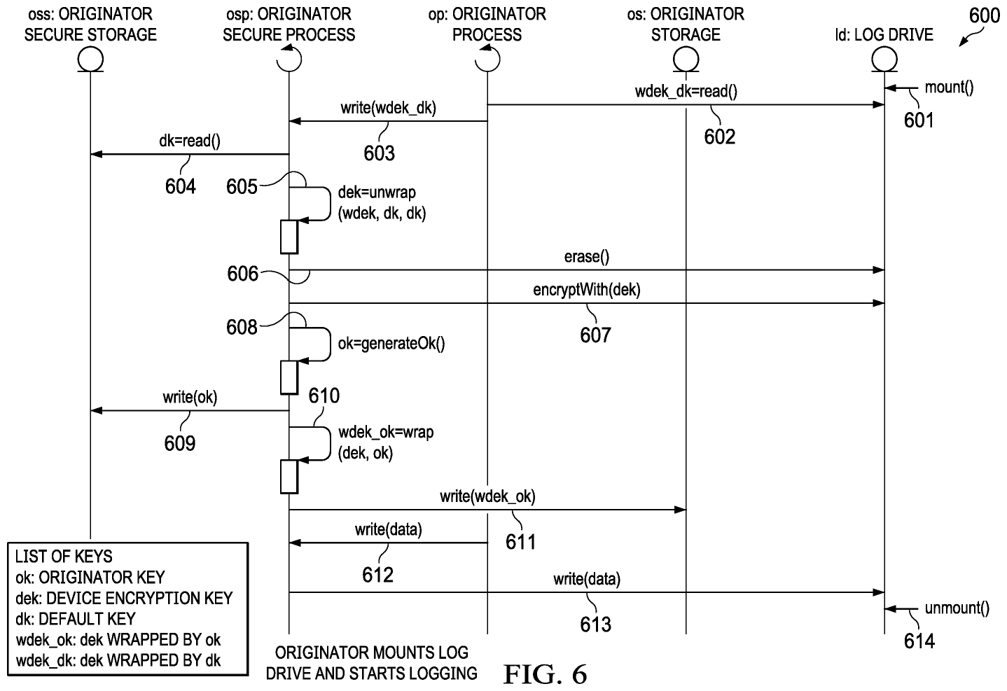

FIG. 6 is a diagram illustrating a procedure 600 where an originator mounts the log drive (601) on an originator computer processor (e.g., computer processor 304 mounted by a file management system and/or operating system) and starts processing the log, according to one or more embodiments. An originator is a system that writes log data to a log drive. In an embodiment, an originator can be an automotive electronic control unit (ECU).

When the log drive is deployed to the originator, an originator process (op) (e.g., a process implemented by an originator computer) reads the wrapped drive encryption key from the log drive (602) and an originator secure process (osp) reads the wrapped drive encryption key into secure hardware (603), reads the default key from originator secure process (604), and unwraps the drive encryption key with the default key (605). In other embodiments, the default key can be wrapped with another key and stored on originator storage (os). The originator secure process wipes (606) and encrypts (607) the entire log drive partition with the drive encryption key or an encryption key derived from the drive encryption key. The originator secure process generates an originator key (ok) in secure hardware (608), writes the originator key to originator secure storage (oss) (609), wraps the drive encryption key with the originator key (610) and writes the drive encryption key wrapped with the originator key onto originator storage (611). The originator process writes data to the originator secure process (612) which writes the data (e.g., appends the data) to the log on the now encrypted log drive (613). Periodically or upon a predefined event, the log drive is unmounted from the originator's computer (614) and mounted on the processor's computer, by a trusted operator in a controlled/secure environment.

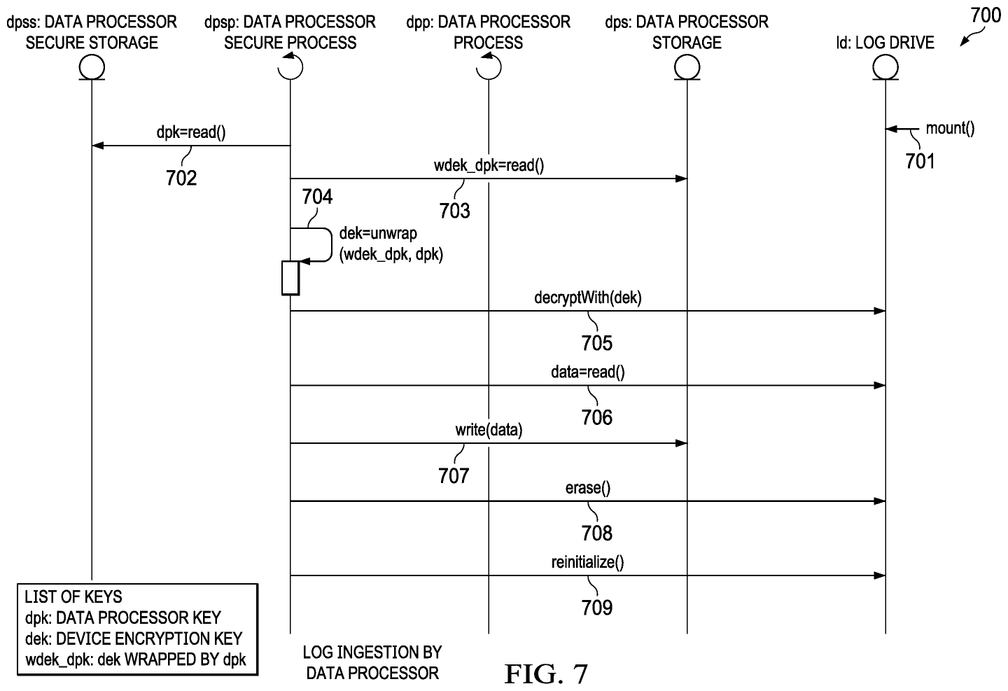

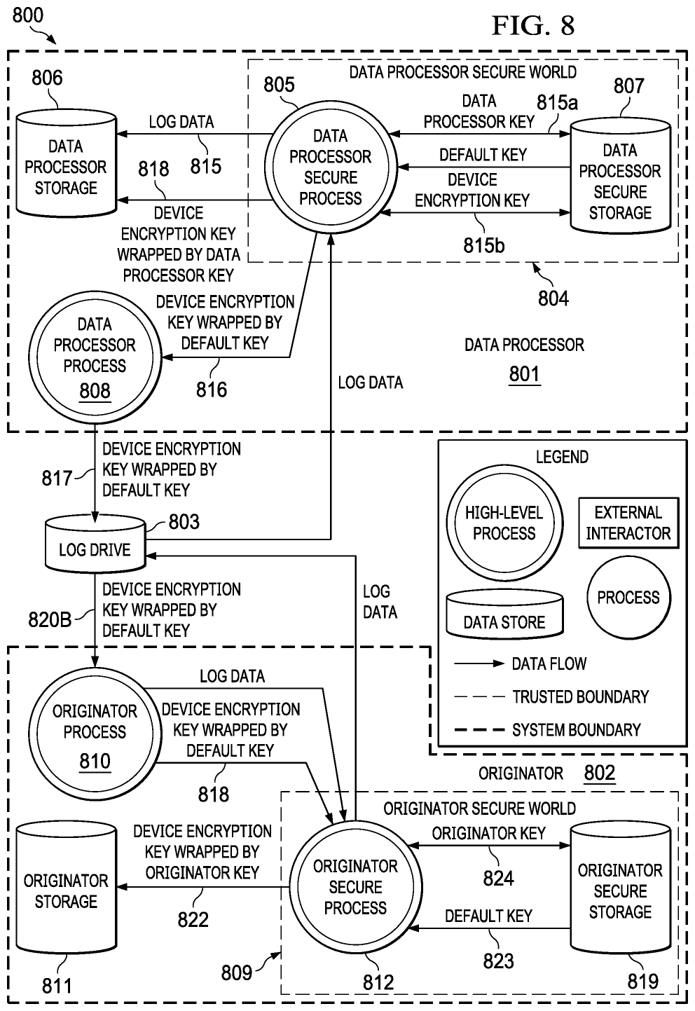

FIG. 7 is a diagram illustrating ingestion 700 by a data processor, according to one or more embodiments. After mounting the log drive (701), data processor secure process reads the processor key from data processor secure storage (702) and uses the log drive's unique ID/serial number to read the wrapped drive encryption key from its database in data processor storage (703). Data processor secure process uses the data processor key to unwrap the wrapped drive encryption key (704), uses the drive encryption key to decrypt the log drive partition (705), retrieves the log data from the log drive (706) and writes the log data to data processor storage (707). Finally, the data processor secure process restarts this cycle all over again by wiping/erasing (708) and reinitializing the log drive (709). The data flow of the processes is described in further detail in reference to FIG. 8.

Note that in FIGS. 5-7, there is reference to various functions, such as, e.g., unwrap( )/wrap( ), encrypt( )/decrypt( ) and read( )/write( ) operations. These functions can be implemented using any known algorithms, methods, processes and/or computer operations, and any known encryption/decryption algorithms, respectively. In an embodiment, the wrapping and unwrapping functions are symmetric encryption algorithms designed to encapsulate (encrypt) cryptographic keys, such as the aforementioned device encryption key. In an embodiment, the wrap and unwrap functions are built from standard primitives such as block ciphers and cryptographic hash functions. Wrap and unwrap algorithms can include but are not limited to: algorithms described in AES Key Wrap Specification (RFC 3394) or the American Standards Committee ANSX9.102 specification, which includes descriptions of AESKW, TDKW, AKW1 and AKW2 key wrapping algorithms.

The read( )/write( ) operations are implemented according to the particular file management system and/or operating system used to read and write data from/to hard drives. Any other suitable key wrapping and cryptographic algorithms are also applicable to the disclosed embodiments.

The above description also references secure hardware. Examples of secure hardware include but are not limited to: a trusted execution environment (TEE), trusted platform module (TPM), or hardware security module (HSM).

FIG. 8 is a data flow diagram for a system 800 for protecting confidentiality of air-gapped logs, according to one or more embodiments. System 800 includes data processor 801, originator 802 and log drive 803. Data processor 801 is a system that reads log data stored on log drive 803. Originator 802 is a system that writes log data to log drive 803. In an embodiment, data processor 802 can be a computer (e.g., computer processor 304) at a log ingestion station and originator 802 can be an automotive electronic control unit (ECU).

In an embodiment, processor 801 includes data processor secure world 804. Data processor secure world 804 is a secure area of a main computer processor (e.g., for TEE) or secure hardware within the processing system (e.g., for TPM/HSM) that ensures code and data loaded inside the data processor secure world 804 is protected with respect to confidentiality and integrity. In this embodiment, the data processor secure process 805 reads (813) encrypted log data from log drive 803 and writes (814) the encrypted log data to data processor storage 806. Data processor storage 806 also stores a default key. The main processor (or a separate hardware processor or processor core) runs a data secure process 805 to read/write (815A, 815B) a device encryption key and data processor key from/to data processor secure storage 807, wraps the device encryption key with the default key, and writes (816) the wrapped key to data processor process 808, which writes (817) the wrapped key to log drive 803. The same or another data processor secure process 805 wraps the device encryption key with a data processor key read from data processor secure storage 807, and writes (818) the wrapped device encryption key to a database in data processor storage 806.

In an embodiment, the drive encryption key and the data processor key are changed each time the log drive is initialized.

In an embodiment, during a second log processing cycle following a first log ingestion cycle, the data processor key and the drive encryption key are replaced by a new data processor key and a new drive encryption key, and the database in data processor storage 806 is updated with the new drive encryption key wrapped by the new data processor key.

In an embodiment, the data processor key and the drive encryption key are generated by a secure process and stored data processor secure storage 807.

In an embodiment, originator 802 includes originator secure world 809. Originator secure world 809 is a secure area of a main computer processor (not shown) that ensures code and data loaded inside the originator secure world 809 is protected with respect to confidentiality, authenticity and integrity. In this embodiment, secure process 812 writes (820A) encrypted log data to log drive 803, reads (820B) the device encryption key wrapped by the default key stored in log drive 803 and writes (821) the device encryption key wrapped by the default key to originator secure process 812. Originator storage 811 stores the default key. The main processor also runs an originator secure process 812 to read/write (824) an originator key from/to originator secure storage 819, write (822) the device encryption key wrapped by the originator key to originator storage 811 and read (823) the default key from originator storage 819.

As can be observed from FIG. 8, the drive encryption key is only available in an unwrapped form in data processor secure world 804 and originator secure world 809 (e.g., secure hardware). For all instances of the drive encryption key stored outside of secure worlds 804, 809, the drive encryption key is wrapped by another key (e.g., processor key, originator key or default key).

In an embodiment, the originator key is generated in secure hardware by a secure process.

In an embodiment, there are two or more originator devices and a unique default key is known to each originator device.

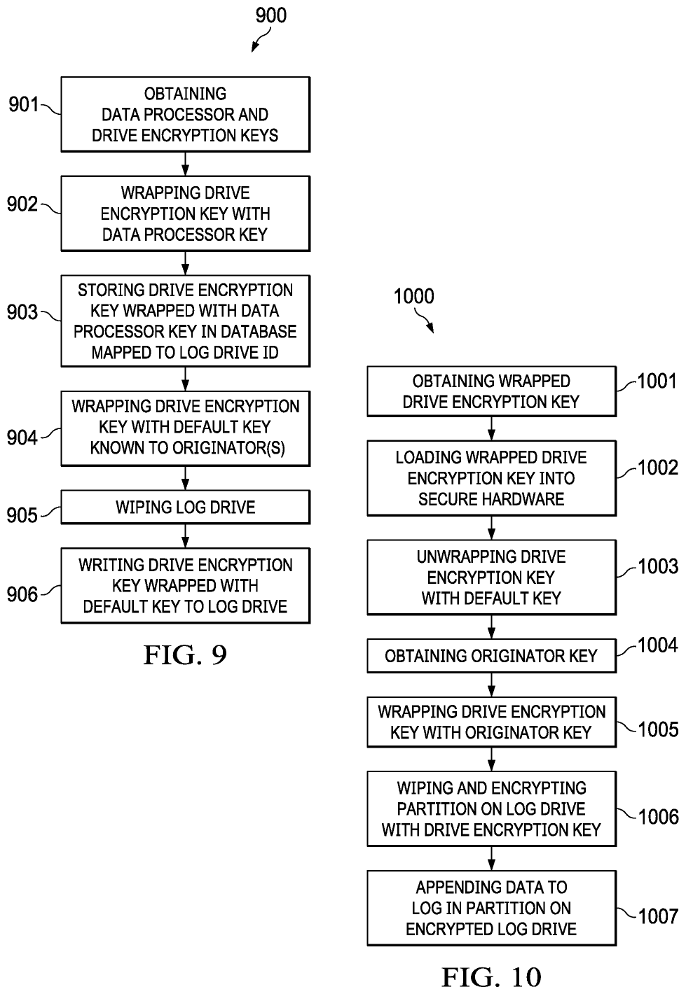

FIG. 9 is a flowchart of a process for protecting confidentiality of air-gapped logs performed by a processor, according to one or more embodiments.

Process 900 includes obtaining, during a first log processing cycle, a data processor key and a drive encryption key (901). The data processor key and the drive encryption key are unique to a log drive mounted to the at least one computer processor, as described in reference to FIG. 5.

Process 900 continues by wrapping the drive encryption key with the data processor key (902) and storing the drive encryption key wrapped by the data processor key in a database (903). In an embodiment, the database is mapped to data uniquely identifying the log drive, such as a unique identifier or serial number.

Process 900 continues by wrapping the drive encryption key with a default key that is known to at least one originator device (904), wiping the log drive (905), and writing the drive encryption key wrapped by the default key to the log drive (906).

FIG. 10 is a flowchart of a process 1000 for protecting confidentiality of air-gapped logs performed by an originator, according to one or more embodiments.

Process 1000 includes obtaining a wrapped drive encryption key (1001), loading the wrapped drive encryption key into secure hardware (1002) and unwrapping the drive encryption key with a default key (1003).

Process 1000 further includes obtaining an originator key (1004), wrapping the drive encryption key with the originator key (1005), erasing a partition of the log drive with the drive encryption key (1006), encrypting the partition of the log drive with the drive encryption key (1007) and appending data to at least one log in the partition on the encrypted log drive (1008).

In the foregoing description, aspects and embodiments of the present disclosure have been described with reference to numerous specific details that can vary from implementation to implementation. Accordingly, the description and drawings are to be regarded in an illustrative rather than a restrictive sense. The sole and exclusive indicator of the scope of the invention, and what is intended by the applicants to be the scope of the invention, is the literal and equivalent scope of the set of claims that issue from this application, in the specific form in which such claims issue, including any subsequent correction. Any definitions expressly set forth herein for terms contained in such claims shall govern the meaning of such terms as used in the claims. In addition, when we use the term “further comprising,” in the foregoing description or following claims, what follows this phrase can be an additional step or entity, or a sub-step/sub-entity of a previously-recited step or entity.

What is claimed is:

1. A method comprising:
obtaining, with at least one computer processor during a first log processing cycle, a data processor key and a drive encryption key, wherein the data processor key and the drive encryption key are unique to a log drive mounted to the at least one computer processor;
wrapping, with the at least one computer processor, the drive encryption key with the data processor key;
storing, with the at least one computer processor, the drive encryption key wrapped by the data processor key in a database, the database mapped to data uniquely identifying the log drive;
wrapping, with the at least one computer processor, the drive encryption key with a default key that is known to at least one originator device;
wiping, with the at least one computer processor, the log drive; and
writing, with the at least one computer processor, the drive encryption key wrapped by the default key to the log drive.

2. The method of claim 1, wherein the drive encryption key and the data processor key are changed each time the log drive is initialized.

3. The method of claim 2, wherein during a second log processing cycle following the first log processing cycle, the data processor key and the drive encryption key are replaced by a new data processor key and a new drive encryption key, and the database is updated with the new drive encryption key wrapped by the new data processor key.

4. The method of claim 1, wherein the data processor key and the drive encryption key are generated in secure hardware.

5. The method of claim 1, wherein the identifier is a serial number of the log drive.

6. The method of claim 1, wherein there are two or more originator devices and a unique default key is known to each originator device.

7. The method of claim 1, further comprising:
unmounting, with the at least one computer processor, the log drive from the at least one computer processor.

8. A method comprising:
obtaining, with at least one computer processor, a wrapped drive encryption key;
loading, with the at least one computer processor, the wrapped drive encryption key into secure hardware;
unwrapping, with the at least one computer processor, the drive encryption key with a default key;
obtaining, with the at least one computer processor, an originator key;
wrapping, with the at least one processor, the drive encryption key with the originator key;
erasing, with the at least one computer processor, a partition of the log drive with the drive encryption key;
encrypting, with the at least one computer processor, the partition of the log drive with the drive encryption key; and
appending, with the at least one computer processor, data to at least one log in the partition on the encrypted log drive.

9. The method of claim 8, further comprising:
periodically or upon a predefined event, mounting the log drive on the at least one computer processor;
fetching, with the at least one computer processor, the wrapped drive encryption key from a database;
unwrapping, with the at least one computer processor, the drive encryption key;
decrypting, with the at least one computer processor, the partition on the log drive using the drive encryption key; and
retrieving, with the at least one computer processor, log data from the partition.

10. The method of claim 9, wherein the at least one computer processor re-initializes the log drive.

11. The method of claim 9, wherein the mounting of the log drive to the at least one computer processor is performed by a trusted operator in a controlled environment.

12. The method of claim 8, wherein the originator key is generated in secure hardware.

13. The method of claim 8, wherein the partition is erased and encrypted with a second drive encryption key derived from the drive encryption key.

14. A system comprising:
at least one computer processor;
memory storing instructions that when executed by at least one computer processor, cause the at least one computer processor, to perform operations comprising:
obtaining, during a first log processing cycle, a data processor key and a drive encryption key, wherein the data processor key and the drive encryption key are unique to a log drive mounted to the at least one computer processor;
wrapping the drive encryption key with the data processor key;
storing the drive encryption key wrapped by the data processor key in a database, the database mapped to data uniquely identifying the log drive;
wrapping the drive encryption key with a default key that is known to at least one originator device;
wiping the log drive; and
writing the drive encryption key wrapped by the default key to the log drive.

15. The system of claim 14, wherein the drive encryption key and the data processor key are changed each time the log drive is initialized.

16. The system of claim 15, wherein during a second log processing cycle following the first log processing cycle, the data processor key and the drive encryption key are replaced by a new data processor key and a new drive encryption key, and the database is updated with the new drive encryption key wrapped by the new data processor key.

17. A system comprising:
at least one computer processor;
memory storing instructions that when executed by at least one computer processor, cause the at least one computer processor, to perform operations comprising:
obtaining a wrapped drive encryption key;
loading the wrapped drive encryption key into secure hardware;
unwrapping the drive encryption key with a default key;
obtaining an originator key;
wrapping the drive encryption key with the originator key;
erasing a partition of the log drive with the drive encryption key;
encrypting the partition of the log drive with the drive encryption key; and
appending data to at least one log in the partition on the encrypted log drive.

18. The system of claim 17, further comprising:
periodically or upon a predefined event, mounting the log;
fetching the wrapped drive encryption key from a database;
unwrapping the drive encryption key;
decrypting the partition on the log drive using the drive encryption key; and
retrieving log data from the partition.

19. The system of claim 17, wherein the originator key is generated in secure hardware.

20. The system of claim 18, wherein the partition is erased and encrypted with a second drive encryption key derived from the drive encryption key.
